(19) United States
(12) Patent Application Publication
(10) Pub. No.: US 2005/0249766 A1
(43) Pub. Date: Nov. 10, 2005

(54) Insecticidal coils

(75) Inventors: Daniel Jeremy Craven, WEST RYDE NEW SOUTH WALES (AU); Guido Sante Dominico Verardo, New South Wales (AU)

Correspondence Address: NORRIS, MCLAUGHLIN & MARCUS, 875 THIRD AVE, 18TH FLOOR, NEW YORK, NY, 10022, US

(73) Assignee: RECKITT BENCKISER (AUSTRALIA) PTY LIMITED, WEST RYDE NEW SOUTH WALES (AU)

(21) Appl. No.: 10/521,136

(22) PCT Filed: Jul. 8, 2003
(86) PCT No.: PCT/GB03/02938

§ 371 Date: Jan. 12, 2005

(30) Foreign Application Priority Data
Jul. 15, 2002 (GB) 0216290.7

(51) Int. Cl. A01N 25/06; A01N 25/18; A01N 25/20

(52) U.S. Cl. 424/405; 424/40

(57) ABSTRACT

A combustible pesticidal product is disclosed which comprises a structural element formed from a pulp of organic fibrous material, cellulose fibres, wood free fibres or mixtures thereof, the product including one or more pesticides which product on combustion emanates the pesticide into the atmosphere. Typically the combustible product will be a mosquito coil which has been impregnated with one or more insecticides effective against mosquitoes. On combustion of the coil, insecticide is emanated into the atmosphere for a period of 7-8 hours.

### TECHNICAL FIELD

This invention relates to moulded combustible products that emanate a pesticide into the atmosphere on combustion and more particularly to such products that undergo combustion for a prolonged period thereby providing an extended time period of pesticidal activity.

### BACKGROUND ART

The kind of products to which this invention relates are commonly referred to as “mosquito coils”. Such coils are characterised by being formed from a combustible material which is shaped into a circular helix. Included in the combustible material are one or more pesticides, which in the case of products active against mosquitoes will be insecticides. As the product burns, the insecticides are emanated into the atmosphere by virtue of their volatility. Ideally, such coils will provide an effective level of insecticide in the atmosphere for an appropriate time period.

Typically, mosquito coils are used in environments where persons sleep and are therefore unable to destroy mosquitoes before being bitten. Another usage is environments where infants or others incapable or having a limited ability of destroying attacking mosquitoes are placed.

It will be readily appreciated that mosquitoes are vectors for a number of particularly persistent and often life-threatening or at least debilitating diseases. Most significant among these diseases is malaria It is therefore highly desirable to prevent mosquito bites as a means of preventing the contracting of such diseases.

Mosquitoes are particularly prevalent in tropical and sub-tropical regions. Many of these regions include countries with relatively low per capita incomes. It is therefore desirable to be able to provide pesticidal products that are highly cost effective. In general terms, traditional mosquito coils fulfil this role. They are relatively easy to form and include low cost ingredients. As emanation of the insecticide is only dependant on combustion of the coil, the only source of energy required is sufficient heat to initially ignite a coil to cause it to combust. However, one feature that is lacking in such coils is the ability to reliably provide a period of sufficient insecticidal activity while a person sleeps overnight. Typically coils should provide up to about 8 hours of insecticidal coverage. However, due to breakage, it is not uncommon for a coil to burn for a significantly shorter period of time. This requires that a person sleeping awake and recognise that the coil is not burning, then carefully relight the unbroken portion whilst ensuring that it is intact and correctly mounted. Such a requirement is not conducive to maintaining an effective overnight coverage against mosquito bites.

At this point it is worth noting that traditional mosquito coils are formed as planar circular helices in a moulding or other shaping process. At the terminal end of the coil, approximately in the centre, is a small aperture which is used to locate the mosquito coil on an upstanding pin. The upstanding pin usually projects out of a dish or tray which is used to collect the ashes of the combusted coil. Locating of the coil on the pin results in the coil separating out so as to form a continuous spiral with the beginning of the coil, which is where combustion commences, at a point lower than the terminal end which sits on the locating pin. In this way the continuous spiral forms a track which combusts from the outer beginning end to the mounted terminal end.

It should be appreciated that mosquito coils may also be formed as double circular helices. In these structures, the helices are formed co-terminously. However, prior to use, each helix must be separated out. One important reason for producing coils in this way is that of economical use of available material as well as ease of formation in manufacture.

As mentioned above, typically mosquito coils are subject to breakage. This arises out of the fact that they are quite brittle and during manufacture, rather than being produced in a planar form, coils may warp to assume a wavy or convex conformation. In some cases, a free end or tip of the coil may curl upwardly. It is therefore well recognised that breakage may occur during manufacture, packaging, transport and in use by a consumer. In this latter case, it is important that a consumer exercise considerable care in both opening and mounting a coil. More especially in the case of double helical coils, care must be taken in separating out each coil so as to avoid breakage. Again it must be emphasised that any breakage of a coil effectively results in a coil being shortened both in length and most significantly, burn time.

Another known method of making mosquito coils is by treating thick pieces of cardboard with an insecticide. The cardboard may be made of layers of thinner sheets which are stacked on top of one another until the desired thickness is achieved. The multi-layered cardboard is then cut to the required shape of the coil. While this method reduces the breakage of the coil, the cutting of the thick cardboard results in the damage and breakage of the cutting knives. The costs associated with the regular replacement of the knives is significant.

Whilst recognising the short comings of traditional mosquito coils, the present inventors have sought to provide an improved coil which is capable of providing a prolonged effective period of insecticidal coverage and is produced in a manner resulting in a cost effective product relative to the traditional coil.

This has been achieved by recognising that rather than forming the coils as planar helices which need to be handled with some care, the coils are moulded to a form which significantly reduces the chance of breakage and does not involve cutting thick cardboard.

### DISCLOSURE OF INVENTION

Accordingly, in a first aspect the present invention consists in a combustible pesticidal product comprising a structural element formed of a vacuum moulded pulp of organic fibrous material, cellulose fibres, wood free fibres, or mixtures thereof, the product including one or more pesticides,

which product on combustion emanates the pesticide into the atmosphere.

In a second aspect, the present invention consists in a method of making a combustible pesticidal product comprising the steps of:

forming a pulp of organic fibrous material, cellulose fibres, wood free fibres, or mixtures thereof,

the addition of one or more pesticides, and

moulding the product by vacuum moulding

to form a combustible pesticidal product.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

For the purposes of describing this invention, reference will be made to mosquito coils, although it must be appreciated that this invention is not so-limited.

In a preferred embodiment, the product is formed by moulding a pulp into the desired shape. Typically the shape will be helical although not necessarily circular.

The pulp is moulded into the shape of a mosquito coil by vacuum moulding, preferably thermoforming.

Vacuum moulding involves feeding a pulp product into a hydropulper to form a solution, a mould covered by a mesh screen being lowered into the solution, and a vacuum being applied to the mould. The use of the vacuum causes fibres to be drawn to the surface of the mould, being a single immersion, or if necessary a number of immersions, and once a sufficient fibre depth is drawn onto the mould the mould is removed from the solution, the vacuum then being used to dewater the pulp. Vacuum moulding can be undertaken at any pressure less than atmospheric pressure however it is more preferable that the pressure is 0-20 kPa (abs) to reduce processing times, These pressures are absolute, ie. the true total pressure of the system that is causing the pulp to form on the mesh. The maximum vacuum achievable is 0 kPa (abs), whilst atmospheric pressure is 101.3 kPa (at sea level and 0° C.). The product may then be transferred from the mould to another mould, with or without compression and dried either in or out of the mould. Methods of drying include but are not limited to direct heat, microwaves or exposure to sunlight. The product is then pressed to the required density either within the mould or after the product has been transferred from the mould.

The thermoforming process is similar to vacuum moulding in that a mould covered by a mesh screen is immersed into a pulp solution and a vacuum is applied to the mould. After a sufficient fibre depth has been drawn onto the mould it is removed from the solution. This mould is then pressed either mechanically or pneumatically or a combination thereof, between a corresponding transfer mould to remove water. This transfer mould may be heated and may also have a vacuum applied to it to aid dewatering. The product may then be held in this transfer mould and moved to another mould for further processing. Further processing may include compression between heated or unheated moulds. Transference of the product from mould to mould can be achieved using compressed air and vacuums. The product is dried in the mould using pressures of between 50 to 1500 kPa, preferably 200 to 600 kPa, most preferably 400 kPa and at a temperature of between 80 to 400° C., preferably 250° C. The product may undergo further processing, for example, stamping or pressing to improve the product qualities.

There are also many permutations for forming the product using both vacuum moulding and thermoforming techniques in different processing orders. Some of these permutations could include;

pressing and heating the product at the same time or separately,

pressing the product after or before drying,

partially drying the product then pressing, preferably followed by further drying,

using heated or unheated moulds,

drying the product either in or out of the mould,

using mechanical or pneumatic means to press and transfer products,

using vacuums and/or compressed air being heated or unheated to aid in dewatering.

To aid transfer of the pulp product from the mould, the sides of the mould may be slightly tapered. An angle of 0-30 degrees, preferably 5-10 degrees is commonly used and is termed the ‘draft angle’.

The advantages of thermoforming over most other methods of processing include high output rates, good quality physical properties in finished parts, namely a smooth surface finish on both sides of the product, density control, and thickness control, and less space and energy requirements as there is no need for a drying oven.

The pulp can be manufactured from readily available and inexpensive combustible organic fibrous materials, cellulose fibres and wood free fibres. Examples, without limitation include waste paper and cardboard, old newspaper, kraft pulp, coconut powder, straw, bagasse, bamboo, cane, straw, grasses, weeds, tea leaves, charcoal powder, sawdust, cotton, cloths, rags, and husks of materials such as rice, wheat and coconuts. Preferably, old newspaper is used.

Whilst this invention is applicable to a variety of pesticidal substances, the preferred form relates to the use of insecticides, particularly insecticides that are effective against mosquitoes.

The insecticides used in this invention comprise all residual insecticides, including non-microencapsulated insecticides, microencapsulated insecticides as well as mixtures of non-microencapsulated and microencapsulated insecticides.

It is preferred that the one or more insecticides comprise substances which are toxic to mosquitoes. Without limitation, these include esbiotbrin, d-allethrin, prallethrin, transfluthrin, bioallethrin, esbioallethrin, pyrethrins, citronella, pyrethroids, neem oil and mixtures thereof. When esbiothrin, d-allethrin, prallethrin, transfluthrin, bioallethrin, esbioallethrin, pyrethrins, and mixtures thereof are used, typically they will be in an amount of from 0.01 to 0.6% w/w, preferably to 0.02 to 0.3% w/w, most preferably 0.04 to 0.1% w/w. When pyrethroids, neem oil, citronella and mixtures thereof are used, typically they will be in an amount of from 0.01 to 10% w/w, preferably to 0.01 to 6% w/w, most preferably 0.04 to 6% w/w.

Emanation of the pesticide into the atmosphere occurs as a result of the pesticide being volatilised as the coil burns. At the front or tip of combustion of a coil, the temperature may be 200-500° C. However, behind the tip, the temperature will be somewhat lower owing to the insulation properties of the pulp. This means that compounds such as esbiothrin which boil at 160-170° C. will be volatised and released into the atmosphere behind the burning tip.

The pulp may include an accelerant, being an alkali earth metal nitrate or nitrite in an amount of from 0.04 to 1.83% w/w. Preferably, the alkali earth metal nitrate or nitrate will be included in an amount of from 0.20 to 1.20% w/w, most preferably about 1.11% w/w. The nitrates or nitrites that may be used include sodium, potassium, calcium, magnesium and mixtures thereof It is preferred to utilise potassium as the nitrate or the nitrite, preferably as the nitrate.

As an alternative to the alkali earth metal nitrate or nitrite, the pulp may include an alkali earth carbonate or bicarbonate in an amount of from 0.02 to 1.83% w/w. Preferably the alkali earth metal carbonate or bicarbonate will be included in an amount of from 0.10 to 1.00% w/w, most preferably about 0.82% w/w. The carbonates or bicarbonates that may be used include sodium, potassium, calcium, magnesium and mixtures thereof.

It is preferred to use potassium carbonate.

Sodium silicate may be included in the pulp in an amount of from 0.01 to 1.37% w/w. Preferably, the sodium silicate may be included in an amount of from 0.10 to 0.70% w/w, most preferably about 0.56% w/w.

A phosphate in an amount of from 0.01 to 0.40% w/w and selected from the group consisting of diammonium phosphate, monoammonium phosphate, triammonium phosphate and mixtures thereof may be included in the pulp. Preferably the phosphate may be included in an amount of from 0.02 to 0.40% w/w, most preferably about 0.14% w/w. Furthermore, of these phosphates, diammonium phosphate is preferred.

A boron compound in an amount of from 0.01 to 0.92% w/w and selected from the group consisting of boric acid, sodium tetraborate hydrous, sodium borate, potassium borate, calcium borate, zinc perborate, boronatrocalcite and mixtires thereof may be included in the pulp. Preferably the boron compound may be included in an amount of from 0.10 to 0.70% w/w, most preferably about 0.66% w/w. Furthermore, of these boron compounds, sodium borate is preferred.

It is within the scope of this invention to include a perfume and/or a dye. Both the perfume and the dye, if included, will be selected on the basis of satisfying specific organoleptic requirements. It will of course be appreciated that the perfume must be suitably stable under the conditions of combustion of the coil.

The thickness and width of the pulp are of great importance in determining the burn rate of the coil. It is desired to have a coil which has a low burn rate as less mass is required in the coil. In a preferred embodiment, the structural element is made from moulded pulp, with dimensions of 3-10 mm wide by 1-6 mm thick, preferably 6 mm wide and 4 mm thick. The desired length is from 500 to 1500 mm, preferably 1100 mm. The cross-sectional combustion area is shaped in a rectangle, triangle, square, half-circle, u section or combinations thereof. Where the coil is a single helical coil, the weight of the single coil is 8 to 20 grams, preferably 12 grams.

It has been found that the density of the pulp is also of importance. To achieve appropriate burn times, the pulp has a density of 300-1000 kg/m³, preferably 400-600 kg/m³, most preferably 600 kg/m³. Low densities burn too rapidly, while high densities have difficulty sustaining combustion. A density of about 600 kg/m³ is preferred as the relatively high density provides rigidity to the coil and ensures that the coil does not need to be too large in size. Coils with a density over 600 kg/m³ will sustain combustion by adding accelerants to the pulp. However, the use of accelerants increases the burn rate of the coil.

Other components that may be added to the pulp or applied as a coating after the product has dried include binders, dewatering agents, chemicals to increase the wet and dry strength of the product, starches, for example, Tapioca, Tamarind and corn; gums, for example, guar, arabic and xanthan; talc, and glues, for example, PVA. Typically, starch is present in an amount of from 5 to 15% w/w. All other components mentioned may be present in amounts of less than 1% w/w.

Broadly speaking, the various materials to be included in the pulp may be either incorporated during the preparation of the pulp, applied as a coating after the moulded pulp product has been formed or both incorporated and applied as a coating. It is preferable that the materials are applied as a coating after the forming of the moulded product.

When a coating is applied, it is important to note that certain of the materials cannot be dissolved in the same solution for coating purposes due to an incompatibility of ingredients. For example, the alkali earth metal nitrate or nitrite and the sodium silicate may be dissolved in the same aqueous solution. Likewise, the alkali metal carbonate or bicarbonate and the sodium silicate; the alkali metal nitrate or nitrite and the phosphate and the alkali metal nitrate or nitrite may each be dissolved in the same aqueous solution.

Whilst the aforementioned materials may be applied as aqueous solutions, the one or more pesticides and the perfume are not generally water soluble. Accordingly, either or both of these materials may be added to the aqueous solution of the other materials along with an emulsifier to ensure that they are uniformly dispersed. Alternatively, they may be dissolved in a solvent and separately applied either before or after the aqueous coating(s).

The inclusion of a dye is optional and depending on the selected dyes solubility may be incorporated in an aqueous solution or in a suitable solvent for separate addition as a coating. If it is incorporated in a non-aqueous solvent, then preferably the solvent will be chosen to dissolve the perfume and the one or more pesticides.

If the dye is incorporated as an aqueous solution, it may be thickened with a suitable thickening agent such as guar gum to form a paste so as to allow application by painting or rolling.

It therefore follows that to apply all of the materials as a coating, a plurality of coatings are required In such circumstances, drying may be carried out to remove excess water between each coating.

Alternatively, all coatings may be sequentially applied and the resultant coated moulded pulp product dried.

Typically the coat weight before drying will be in the range of from 5 to 240 gm⁻², preferably 5-50 gm⁻². In those instances where all of the materials are applied as a coating, the coat weight is most preferably 30-50 gm⁻².

Application of the coatings may occur using techniques such as rolling, painting, printing or spraying. Naturally, the materials must be dissolved or dispersed in a liquid that is capable of application, desirably to obtain a uniform coating. If printing is used, well known techniques such as offset printing, gravure printing and lithographic printing may be used.

When produced as mosquito coils, the products of the invention may burn typically for up to 24 hours. By adjusting parameters such as the density, thickness, width and mass of coil, various burn times may be obtained. For example, burn times of at least 4 hours, preferably 7-8 hours may be obtained. It will also be appreciated that the amount of the various additives such as the alkali earth metal nitrate or nitrite, the sodium silicate, the phosphate and the boron compound will affect burn time.

### BRIEF DESCRIPTION OF THE DRAWINGS

FIG. 1 is a graph showing the effect of width and thickness on the burn rate of the product with a density of 380±25 kg/m³.

FIG. 2 is a graph showing the effect of width on burn rate of three different products with a density of 450±50 kg/m³.

FIG. 3a is a plan view of the moulding apparatus of Example 1

FIG. 3b is a sectional view A-A of FIG. 3a

FIG. 4 is a view of the vacuum apparatus used in conjunction with the moulding apparatus.

In order to better understand the nature of the invention, a number of examples will now be described.

### EXAMPLE 1

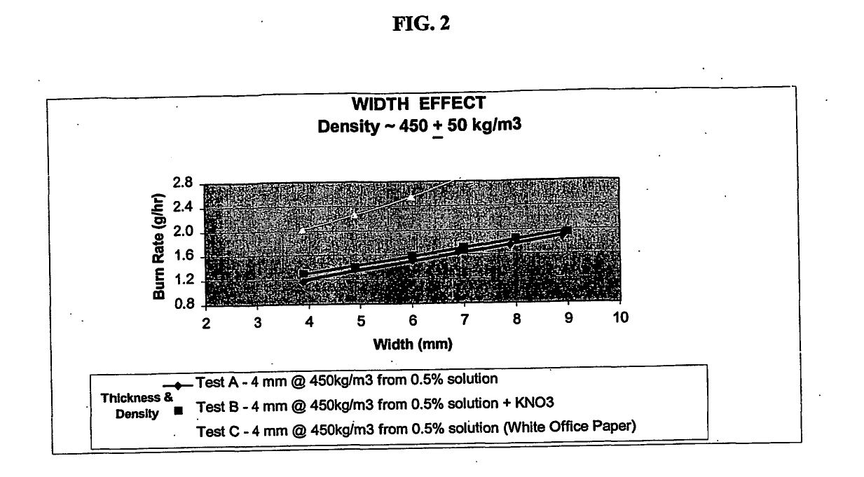

As shown in FIG. 3b the moulding apparatus 10 comprises four metal components 11,12,13 and 14. The components are a support plate 11, overlaid by a stainless steel mesh screen 12, a suction mould 13, and a press tool 14. Mesh screen 12 is fixed to the mould 13 using fasteners at location 15 in a manner such that the screen is sandwiched between support plate 11 and mould 13.

In use, the mould 13 is placed into a vacuum vessel 16 containing water 17 which is connected to a vacuum pump 18 by a vacuum hose 19 as shown in FIG. 4. A 0.5% pulp solution was made by dispersing old newspaper in water with no additives. The pulp solution was poured into the mould 13 and the pressure was reduced to between 3 and 50 kPa (abs) using a vacuum pump. Once the pulp solution had all been added and sufficiently dewatered the press tool 14 was pressed down into the mould 13 as is best seen in FIG. 4. This further dewatered the pulp and was found to produce samples of relatively consistent quality that had a density of about 300 kg/m³. The moulding apparatus 10 was then dismantled and the pulp strips removed and dried in an oven at 65° C. To achieve densities greater than 300 kg/m³, the pulp strips were placed back in the mould 13 after drying and compressed between the press tool 14 and the support plate 11 using a hydraulic press. Old newspaper was found to sustain combustion at densities below 600 kg/m³ without the need for accelerants.

### EXAMPLE 2

Trials were conducted to compare the effect on burn rate when the thickness, width and density of the strips were altered. Strips were produced of lengths between 4-9 mm, with a thickness of 2, 3, 4 and 5 mm at densities of 300, 450 and 600 kg/m³. These strips were then burnt to determine their mass burn rate in g/h.

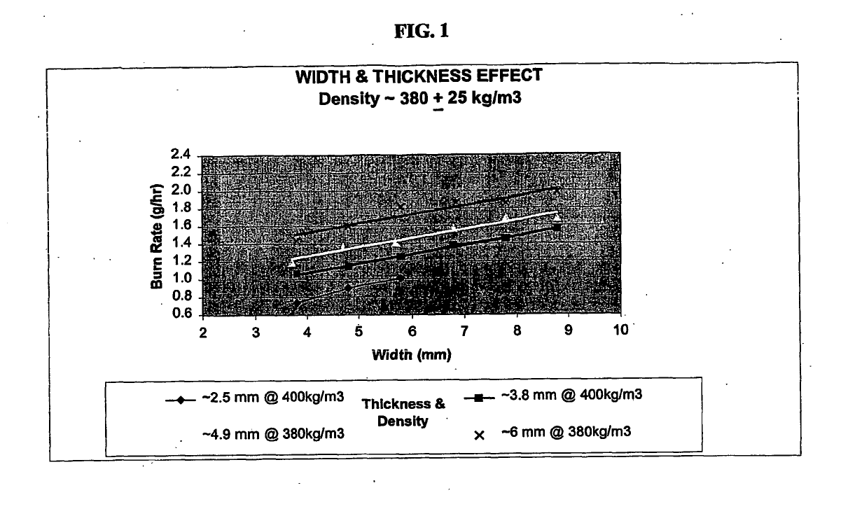

FIG. 1 shows the effect of varying thickness and widths on burn rate.

The observed trends were that increasing width increases burn rate, and increasing thickness increases burn rate.

FIG. 2 shows the effect on the burn rate of the product with a density of 450±50 kg/m³ when an accelerant (KNO₃) is added to newspaper pulp and also when using white office paper instead of old newspaper as the main ingredient.

### EXAMPLE 3

Trials were conducted to compare the effect on burn rate when white office paper was used as the main ingredient and also when the accelerant potassium nitrate (KNO₃) was used with old newspaper. KNO₃ was added at a concentration of 0.125% in the pulp solution. FIG. 2 shows that using white office paper as a raw material increases the burn rate dramatically. Likewise the addition of KNO₃ to old newspaper slightly increases the burn rate compared to old newspaper with no additives.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A combustible pesticidal product comprising a structural element having a thickness defined by sides which slope at an angle of from 5 to 10 degress and formed of a vacuum moulded pulp of organic fibrous material, cellulose fibres, wood free fibres, or mixtures thereof, the product including one or more pesticides,
which product on combustion emanates the pesticide into the atmosphere.

2. A combustible pesticidal product according to claim 1 wherein the product is formed of a thermoformed pulp.

3. A combustible pesticidal product according to claim 2 wherein the product is thermoformed at a temperature of between 80 to 400° C., and at a pressure of between 50 to 1500 kPa.

4. (canceled)

5. (canceled)

6. (canceled)

7. A combustible pesticidal product according to claim 1 wherein the product comprises at least one of the following:
an alkali or alkali earth metal nitrate or nitrite in an amount of from 0.04 to 1.83% w/w,
an alkali or alkali earth carbonate or bicarbonate in an amount of from 0.01 to 1.00% w/w;
sodium silicate in an amount of from 0.01 to 1.37% w/w;
a phosphate in an amount of from 0.01 to 0.40% w/w and selected from the group consisting of diammonium phosphate, monoammonium phosphate, triammonium phosphate and mixtures thereof;
a boron compound in an amount of from 0.01 to 0.92% w/w and selected from the group consisting of boric acid, sodium tetraborate hydrous, sodium borate, potassium borate, calcium borate, zinc perborate, boronatrocalcite and mixtures thereof; and optionally a perfume and/or dye
which is incorporated into the wet pulp during its preparation or applied to a pulp as a coating.

8. Combustible pesticidal product according to claim 1 in which the one or more pesticides are insecticides.

9. A combustible pesticidal product according to claim 48 wherein the one or more pesticides are present in an amount of from 0.01 to 0.6% w/w.

10. (canceled)

11. (canceled)

12. A combustible pesticidal product according to claim 48 wherein the one or more pesticides are insecticides selected from the group consisting of pyrethroids, neem oil, citronella and mixtures thereof and are in an amount of from 0.01 to 10% w/w.

13. (canceled)

14. (canceled)

15. A combustible pesticidal product according to claim 7 wherein the alkali earth metal nitrate or nitrite is included in an amount of from 0.20 to 1.20% w/w.

16. (canceled)

17. (canceled)

18. (canceled)

19. (canceled)

20. A combustible pesticidal product according to claim 7 wherein the sodium silicate is included in an amount of from 0.01 to 0.70% w/w.

21. (canceled)

22. A combustible pesticidal product according to claim 7 wherein the phosphate is included in an amount of from 0.02 to 0.40% w/w.

23. (canceled)

24. A combustible pesticidal product according to claim 22 wherein the phosphate is diammonium phosphate.

25. A combustible pesticidal product according to claim 7 wherein the boron compound is included in an amount of from 0.10 to 0.70% w/w.

26. (canceled)

27. A combustible pesticidal product according to claim 1 wherein the thickness of the pulp product is from 1 mm to 6 mm.

28. (canceled)

29. A combustible pesticidal product according to claim 1 wherein the width of the pulp product is from 3 mm to 10 mm.

30. (canceled)

31. A combustible pesticidal product according to claim 1 wherein the length of the pulp product is from 500 to 1500 mm.

32. (canceled)

33. A combustible pesticidal product according to claim 1 wherein the density of the pulp product is from 300 to 1000 kg/m3.

34. (canceled)

35. (canceled)

36. A combustible pesticidal product according to claim 1 wherein the product has a cross-sectional combustion area shaped in a rectangle, triangle, square, half-circle, u section or combinations thereof.

37. (canceled)

38. (canceled)

39. (canceled)

40. (canceled)

41. A combustible pesticidal product according to claim 1 wherein the product is a mosquito coil having a burn time of at least 4 hours.

42. A combustible pesticidal product according to claim 41 wherein the mosquito coil has a burn time of 7-8 hours.

43. A combustible pesticidal product according to claim 41 wherein the coil is shaped as a single helical coil, double coil, triangular, hexagon, polygon or rectangular.

44. A combustible pesticidal product according to claim 43 wherein the coil is a single helical coil and the weight of the single coil is 8 to 20 grams.

45. (canceled)

46. A method of making a combustible pesticidal product comprising the steps of:
forming a pulp of organic fibrous material, cellulose fibres, wood free fibres, or mixtures thereof,
adding of one or more pesticides to the pulp, and
moulding the pulp containing the one or more pesticides by vacuum moulding to form a combustible pesticidal product.

47. A method of making a combustible pesticidal product according to claim 46 wherein the product is formed at a vacuum pressure of 0-20 kPa.

48. Combustible pesticidal product according to claim 8 wherein the one or more pesticides are insecticides selected from pyrethroids including, esbiothrin, d-allethrin, prallethrin, transfluthrin, bioallethrin, esbioallethrin and pyrethrins, citronella, neem oil and mixtures thereof.
